(19) United States
(12) Patent Application Publication
(10) Pub. No.: US 2026/0348234 A1
(43) Pub. Date: Nov. 5, 2026

(54) ROLLER SHUTTER DRIVING APPARATUS

(71) Applicant: Guangdong Leafy Windoware Co., Ltd., Huizhou, Guangdong (CN)

(72) Inventors: Zhenbang LEI, Huizhou, Guangdong (CN); Xingbang LEI, Huizhou, Guangdong (CN)

(21) Appl. No.: 19/167,862

(22) PCT Filed: Oct. 20, 2023
(86) PCT No.: PCT/CN2023/125606

§ 371 Date: Jul. 27, 2026

(51) Int. Cl. E06B 9/68

(52) U.S. Cl. CPC E06B 9/68

(57) ABSTRACT

Embodiments of the present application provide a roller shutter driving apparatus, comprising a shaft rod coaxially arranged with a winding drum, a driver arranged in the winding drum, and a transmission mechanism arranged between an output shaft and the shaft rod. The driver comprises a base and a rotary power member; a preset non-zero included angle is formed between the central axes of the output shaft of the rotary power member and the shaft rod. The transmission mechanism comprises a guide rod fixed relative to the base, a guide sleeve slidably sleeved on the guide rod, and two connector modules respectively connected to the guide sleeve; the guide sleeve comprises a main sleeve and two sliding rods symmetrically protruding outwards from two opposite sides of the main sleeve; each connector module comprises a sliding sleeve slidably sleeved on one corresponding sliding rod and an adapter rod having one end pivotally connected to the sliding sleeve; the other end of one of and the other end of the other of the two adapter rods respectively belonging to the two connector modules are respectively fixed at the tail end of the output shaft and the tail end of the shaft rod in a one-to-one correspondence manner, and the ends of the adapter rods pivotally connected to the sliding sleeves respectively deviate from the central axes of the output shaft and the shaft rod. The present embodiment can effectively reduce the occupied volume.

### FIELD OF THE PRESENT INVENTION

The present invention relates to the technical field of curtain accessories and, more particularly to a roller shutter driving apparatus.

### BACKGROUND OF THE PRESENT INVENTION

Two ends of a winding drum of a current roller shutter are respectively installed on corresponding support frames, and a roller shutter driving apparatus assembled inside the winding drum drives the winding drum to retract or release a curtain fabric. A current roller shutter driving apparatus mainly includes a driver set inside the winding drum, a shaft fixed on the support frame at an outer side of one end of the winding drum and inserted into the winding drum, and a transmission mechanism for power transmission between the driver and the shaft. The driver includes a driving housing fixed relative to the winding drum and a rotating power component set inside the driving housing.

However, the inventor found in the specific implementation that an output shaft and the shaft of the rotating power component inside the traditional roller shutter driving apparatus are usually arranged in parallel, resulting in a relatively complex structure of the transmission mechanism and a relatively large overall volume of the driving apparatus, which is not conducive to the miniaturization design of the roller shutter.

### SUMMARY OF THE INVENTION

### Technical Problem

Therefore, the technical problem to be solved by the embodiments of the present invention is to provide a roller shutter driving apparatus, which can effectively reduce the occupied volume.

### Solutions to the Problem

To solve the above-mentioned technical problems, an embodiment of the present invention provides the following solutions. A roller shutter driving apparatus includes a shaft rod fixed to a support frame at an outer side of one end of a winding drum of a roller shutter and inserted into the winding drum and coaxially arranged with the winding drum, a driver arranged inside the winding drum for driving the winding drum to rotate about the shaft rod, and a transmission mechanism; the driver includes a base fixed relative to the winding drum in a circumferential direction, and a rotary power member fixed to the base; central axes of an output shaft of the rotary power member and the shaft rod have a predetermined non-zero angle; the transmission mechanism is arranged between the output shaft and the shaft rod, and includes a guide rod fixed relative to the base, a guide sleeve slidably fitted about the guide rod, and two connector modules connected to the guide sleeve; the guide sleeve includes a main sleeve and two sliding rods symmetrically protruding out from opposite sides of the main sleeve; each connector module includes a sliding sleeve slidably fitted about a corresponding sliding rod, and an adapter rod rotatably connected to the sliding sleeve with one end; the other ends of the two adapter rods belonging to the two connector modules are respectively fixed to a distal end of the output shaft and a distal end of the shaft rod, and the ends of the adapter rods rotatably connected to the sliding sleeves deviate from the central axes of the output shaft and the shaft rod, respectively.

Furthermore, one end of the adapter rod is formed with a U-shaped fork frame, the sliding sleeve protrudes from opposite sidewalls with two circular shafts that are coaxial with each other and perpendicular to an axis of a central hole of the sliding sleeve; the sliding sleeve is placed inside the fork frame, and the circular shafts are inserted into corresponding rotation holes defined in two opposite fork arms of the fork frame.

Furthermore, the central axes of the output shaft of the rotary power member and the shaft rod are perpendicular to each other.

Furthermore, the shaft rod comprises an inner shaft and an outer shaft that are coaxially fixedly connected, the inner shaft is located entirely inside the winding drum, and defines an insertion hole for receiving a corresponding adapter rod in a sidewall of one end away from the outer shaft; an end of the outer shaft that is away from the inner shaft extends outside the winding drum, and is fixed to the support frame.

Furthermore, the rotary power member includes a winding core shaft and a transmission shaft that are arranged parallel to each other and rotatably mounted to the base, and a planar spiral spring wound on the winding core shaft and fixed at an outer end to the transmission shaft; wherein the transmission shaft is connected to the output shaft through a gear pair for transmission.

Furthermore, the gear pair includes a driving gear fixed coaxially with the transmission shaft, a driven gear fixed coaxially with the output shaft, and a transition gear rotatably mounted to the base and meshing with the driving gear and the driven gear on both sides.

Furthermore, the winding core shaft and the transition gear are coaxially arranged and rotatably fitted about a rotation shaft; corresponding shaft holes are defined in the base, for opposite ends of the rotation shaft being inserted therein.

Furthermore, the roller shutter driving apparatus further includes a protective housing that covers the guide rod, the guide sleeve, the connector modules, the output shaft, and the driven gear; the shaft rod and a gear surface of the transition gear respectively extend into the protective housing through openings predetermined defined in opposite sidewalls of the protective housing, the output shaft is rotatably mounted to the protective housing, and opposite ends of the guide rod are respectively inserted and fixed into corresponding positioning holes defined in opposite inner walls of the protective housing.

Furthermore, the protective housing is formed by interlocking a first half shell and a second half shell, the first half shell is integrally formed with a support bushing on one end adjacent to the outer shaft, and the outer shaft is correspondingly inserted into the support bushing, the inner shaft is assembled on a corresponding bearing seat formed inside the protective housing by means of a bearing.

Furthermore, the base is a driving housing that covers the winding core shaft, the transmission shaft, the planar spiral spring, the driving gear, and the transition gear; the driving housing is abutted to and fixedly connected to the protective housing, and a through hole is defined in a housing wall at one end of the driving housing for the gear surface of the transition gear to extend out.

### Beneficial Effects of the Invention

By adopting the above technical solution, embodiments of the present invention have at least the following beneficial effects. The embodiments set the central axes of the output shaft of the rotary power member and the shaft rod to be perpendicular to each other and have a predetermined non-zero spacing, which is conducive to reducing the occupied volume of the driving apparatus, and further add a transmission mechanism including a guide rod, a guide sleeve, and two connector modules; wherein the guide sleeve includes a main sleeve and two sliding rods, and each connector module includes a sliding sleeve and an adapter rod; when one of the connector modules rotates under the drive of the output shaft, due to the rotation connection between the sliding sleeve and the adapter rod and the adapter rods of the two connector modules being fixedly connected to the output shaft and the shaft rod, and due to the sliding sleeve being rotatably fitted about the sliding rod, at the same time, one end of the sliding rod is connected to the main sleeve fitted about the guide rod, and thus, while the sliding sleeve moves in a circular motion, it also drives the sliding rod and the guide sleeve to reciprocate along the axial direction of the guide rod; synchronously, the other connector module rotates about its own central axis under the driving of the guide sleeve, thereby driving the winding drum to rotate about the shaft rod, and using the transmission mechanism to achieve power transmission between the output shaft and the shaft rod. The overall structure is more compact and can effectively reduce the volume occupied by the driving apparatus.

### BRIEF DESCRIPTION OF THE DRAWINGS

FIG. 1 is an exploded, isometric view of an embodiment of a roller shutter driving apparatus.

FIG. 2 is an assembled, isometric view of a transmission mechanism of the roller shutter driving apparatus.

FIG. 3 is an assembled, isometric view of the roller shutter driving apparatus.

FIG. 4 is a cross-sectional view of the transmission mechanism of the roller shutter driving apparatus.

FIG. 5 is a cross-sectional view of a driver of the roller shutter driving apparatus.

FIG. 6 is an exploded, isometric view of the driver of the roller shutter driving apparatus.

### DETAILED DESCRIPTION OF THE PRESENT INVENTION

The present application will be further described in detail below with reference to the accompanying drawings and embodiments. It should be understood that the following illustrative embodiments and illustrations are only used to explain the present invention and are not intended to limit the present invention, and that the embodiments of the present invention and the features of the embodiments can be combined with each other without conflict.

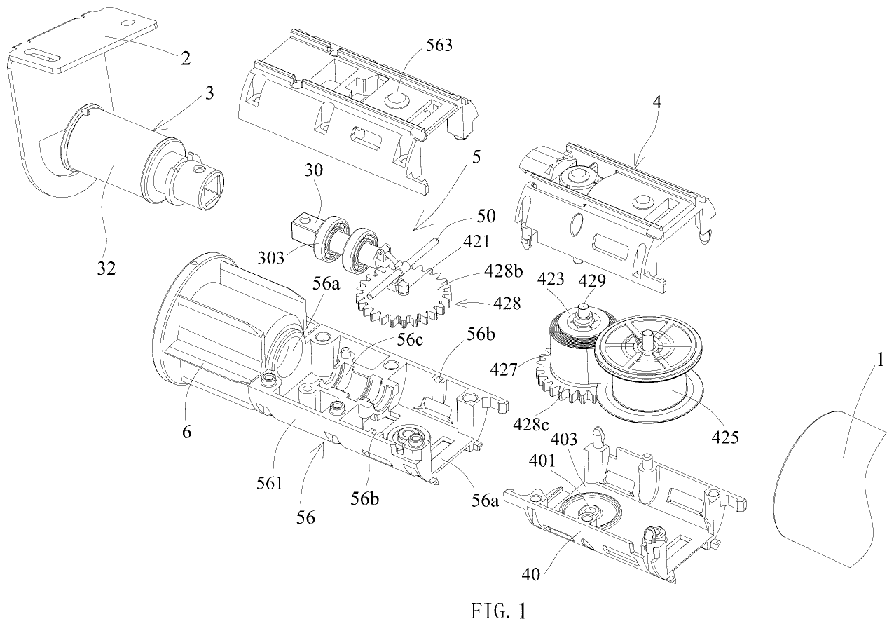

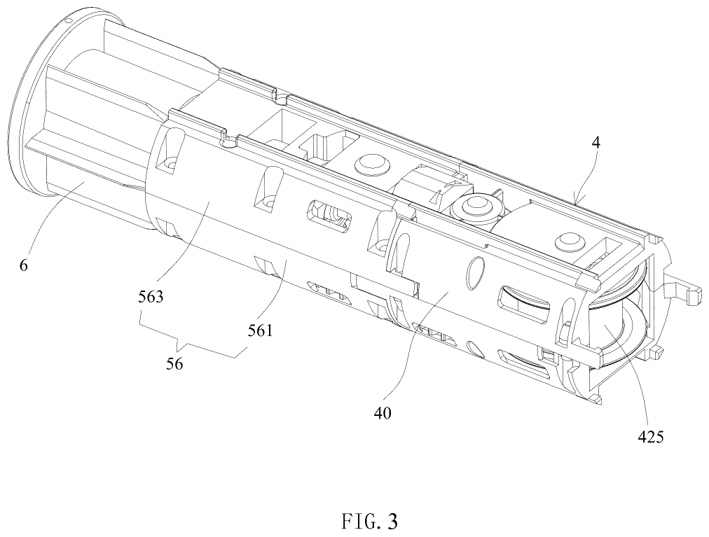

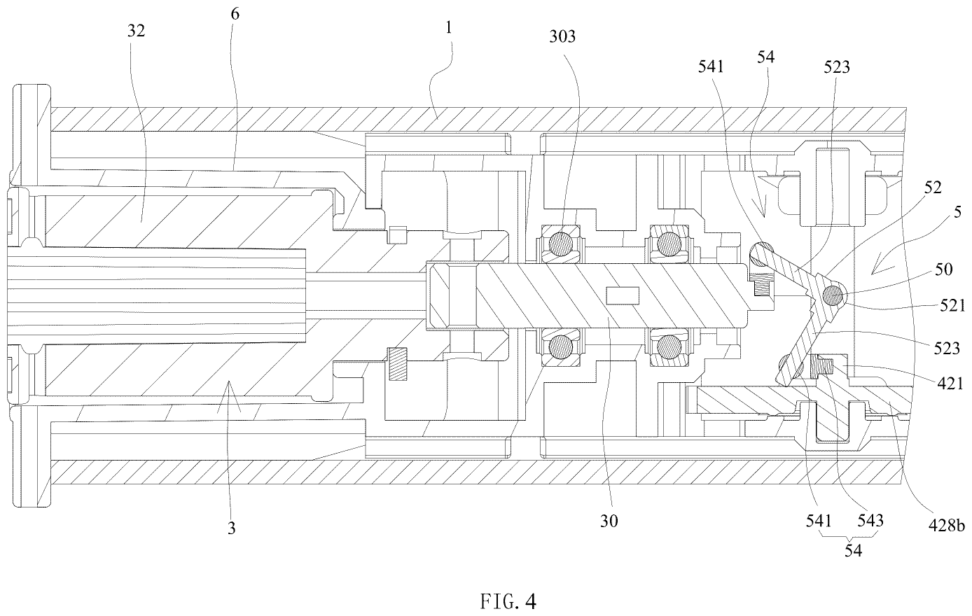

Referring to FIGS. 1-4, an embodiment of the present invention provides a roller shutter driving apparatus, which includes a shaft rod 3 fixed to a support frame 2 at an outer side of one end of a winding drum 1 of a roller shutter and inserted into the winding drum 1 and coaxially arranged with the winding drum 1, and a driver 4 arranged inside the winding drum 1 for driving the winding drum 1 to rotate about the shaft rod 3. The driver 4 includes a base 40 fixed relative to the winding drum 1 in a circumferential direction, and a rotary power member 42 fixed to the base 40. Central axes of an output shaft 421 of the rotary power member 42 and the shaft rod 3 have a predetermined non-zero angle. The roller shutter driving apparatus further includes a transmission mechanism 5 arranged between the output shaft 421 and the shaft rod 3. The transmission mechanism 5 includes a guide rod 50 fixed relative to the base 40, a guide sleeve 52 slidably fitted about the guide rod 50, and two connector modules 54 connected to the guide sleeve 52. The guide sleeve 52 includes a main sleeve 521 and two sliding rods 523 symmetrically protruding out from opposite sides of the main sleeve 521. Each connector module 54 includes a sliding sleeve 541 slidably fitted about a corresponding sliding rod 523, and an adapter rod 543 rotatably connected to the sliding sleeve 541 with one end. The other ends of the two adapter rods 543 belonging to the two connector modules 54 are respectively fixed to a distal end of the output shaft 421 and a distal end of the shaft rod 3, and the ends rotatably connected to the sliding sleeves 541 deviate from the central axes of the output shaft 421 and the shaft rod 3, respectively.

The embodiment sets the central axes of the output shaft 421 of the rotary power member 42 and the shaft rod 3 to have a predetermined non-zero angle, which is conducive to reducing the occupied volume of the driving apparatus. Furthermore, the transmission mechanism 5 is added, which includes the guide rod 50, the guide sleeve 52, and the two connector modules 54. The guide sleeve 52 includes the main sleeve 521 and the two sliding rods 523, and each connector module 54 includes the sliding sleeve 541 and the adapter rod 543. When one of the connector modules 54 rotates under the drive of the output shaft 421, due to the rotation connection between the sliding sleeve 541 and the adapter rod 543 and the adapter rods 543 of the two connector modules 54 being respectively fixedly connected to the output shaft 421 of the rotary power component 42 and the shaft rod 3, the sliding sleeve 541 performs circular motion while also drives the sliding rod 521 and the guide sleeve 52 to reciprocate along the axial direction of the guide rod 50, and synchronously, the outer connection shaft 545 of the other connector module 54 rotates about its own central axis under the driving of the guide sleeve 52, thereby driving the winding drum 2 to rotate about the shaft rod 3, and using the transmission mechanism 5 to achieve power transmission between the output shaft 421 and the shaft rod 3. The overall structure is more compact and can effectively reduce the volume occupied by the driving apparatus. In specific implementation, it is preferable to design the two sliding rods 523 to be perpendicular to each other.

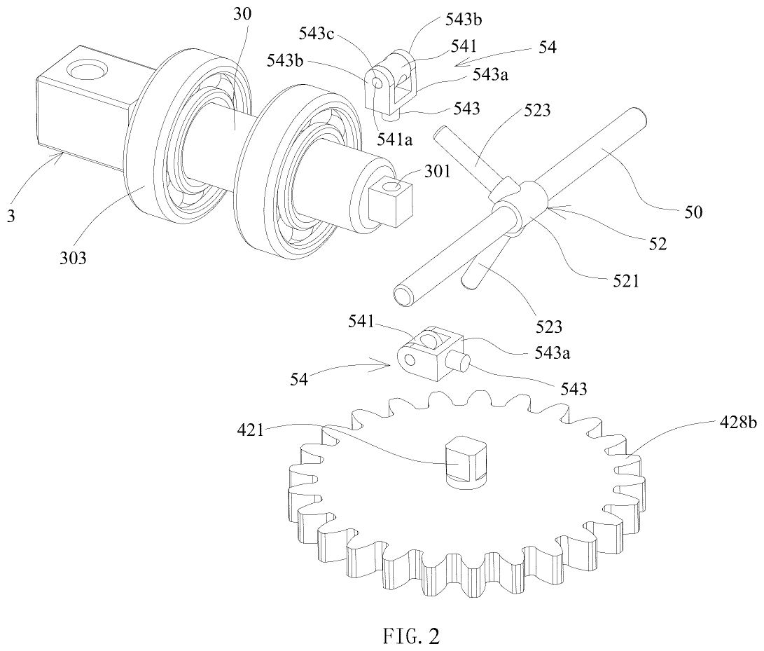

In an embodiment, as shown in FIGS. 1 and 2, one end of the adapter rod 543 is formed with a U-shaped fork frame 543a. The sliding sleeve 541 protrudes from opposite sidewalls with two circular shafts 541a that are coaxial with each other and perpendicular to an axis of a central hole of the sliding sleeve 541. The sliding sleeve 541 is placed inside the fork frame 543a, and the circular shafts 541a are inserted into corresponding rotation holes 543c in two opposite fork arms 543b of the fork frame 543a. In the embodiment, the circular shafts 541a on both sides of the sliding sleeve 541 are correspondingly inserted into the rotation holes 543c of the two fork arms 543b of the fork frame 543a, which can effectively achieve the rotation connection between the sliding sleeve 541 and the fork frame 543a, and the assembly is relatively convenient.

In an embodiment, the central axes of the output shaft 421 of the rotary power member 42 and the shaft rod 3 are perpendicular to each other. In the embodiment, by making the central axes of the output shaft 421 and the shaft rod 3 be perpendicular to each other, the overall volume occupied by the apparatus can be minimized to the greatest extent.

In an embodiment, as shown in FIGS. 1, 2, and 4, the shaft rod 3 includes an inner shaft 30 and an outer shaft 32 that are coaxially fixedly connected. The inner shaft 30 is located entirely inside the winding drum 1, and defines an insertion hole 301 for receiving one corresponding adapter rod 543 in a sidewall of one end away from the outer shaft 32. An end of the outer shaft 32 that is away from the inner shaft 30 extends outside the winding drum 1, and is fixed to the support frame 2. In the embodiment, by designing the shaft rod 3 as a fixed and coaxial connection of the inner shaft 30 and the outer shaft 32, it can be easily manufactured and assembled. In specific implementation, one end of the inner shaft 30 is inserted into a mating hole in a corresponding end face of the outer shaft 32, and then is locked from a side by inserting a pin to achieve the fixed connection.

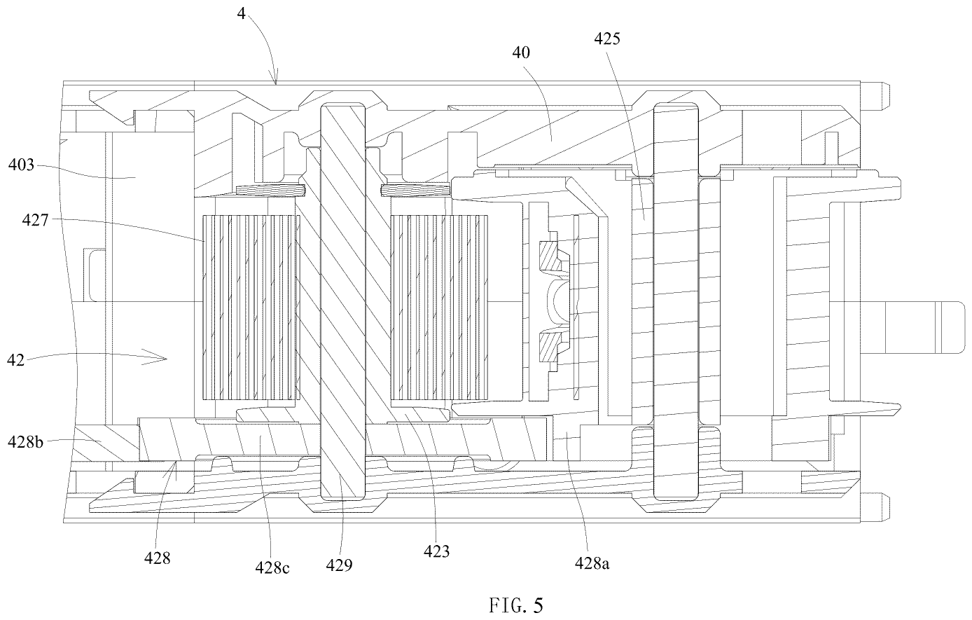

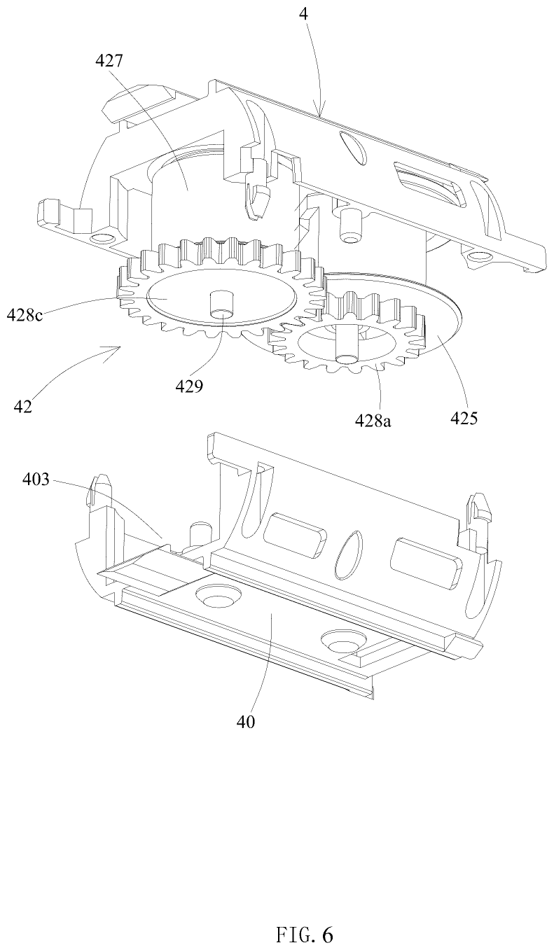

In an embodiment, as shown in FIGS. 1, 5, and 6, the rotary power member 42 further includes a winding core shaft 423 and a transmission shaft 425 that are arranged parallel to each other and rotatably mounted to the base 40, and a planar spiral spring 427 wound on the winding core shaft 423 and fixed at the outer end to the transmission shaft 425. The transmission shaft 425 is connected to the output shaft 421 through a gear pair 428 for transmission. The embodiment adopts the winding core shaft 425 and the transmission shaft 425 arranged parallel to each other in the axial direction, the planar spiral spring 424 functions as a power component to drive the transmission shaft 425 to rotate, and then the output shaft 421 is driven to rotate by the gear pair 428. It is easy to install, provides strong controllability of the driving force, and can better design the driving force required for the retracting and releasing of the curtain fabric. The overall structure is simple, easy to assemble, and easy to control.

In an embodiment, as shown in FIG. 1, and 4-6, the gear pair 428 includes a driving gear 428a fixed coaxially with the transmission shaft 425, a driven gear 428b fixed coaxially with the output shaft 421, and a transition gear 428c rotatably mounted on the base 40 and meshing with the driving gear 428a and the driven gear 428b on both sides. In the embodiment, the gear pair 428 includes the driving gear 428a, the driven gear 428b, and the transition gear 428c, and by using the step-by-step transmission of a rotational power through the three gears, the transmission efficiency can be improved by designing the transmission ratio of the three gears.

In an embodiment, as shown in FIG. 1, and 4-6, the winding core shaft 423 and the transition gear 428c are coaxially arranged and rotatably fitted about a rotation shaft 429. Corresponding shaft holes 401 are defined in the base 40, for opposite ends of the rotation shaft 429 being inserted therein. In the embodiment, the winding core shaft 423 and the transition gear 428c are fitted about the same rotation shaft 429, which can rotate independently about the rotation shaft 429 without interfering with each other, and can optimize the spatial layout of the structure to reduce volume.

In an embodiment, as shown in FIG. 1, and 4-6, the roller shutter driving apparatus further includes a protective housing 56 that covers the guide rod 50, the guide sleeve 52, the connector modules 54, the output shaft 421, and the driven gear 428b. The shaft rod 3 and a gear surface of the transition gear 428c respectively extend into the protective housing 56 through predetermined openings 56a defined in opposite sidewalls of the protective housing 56. The output shaft 421 is rotatably mounted to the protective housing 56, and opposite ends of the guide rod 50 are respectively inserted and fixed into corresponding positioning holes 56b defined in opposite inner walls of the protective housing 56. In the embodiment, the protective housing 56 is provided, which can accommodate movable components such as the guide rod 50, the guide sleeve 52, the connector modules 54, the output shaft 421, and the driven gear 428b, to avoid external foreign objects interfering with the operation of the movable components, optimize the overall structural layout, and achieve modular assembly.

In an embodiment, as shown in FIG. 1, and 4-6, the protective housing 56 is formed by interlocking a first half shell 561 and a second half shell 563. The first half shell 561 is also integrally formed with a support bushing 6 on one end adjacent to the outer shaft 32, and the outer shaft 32 is correspondingly inserted into the support bushing 6. The inner shaft 30 is also assembled on a corresponding bearing seat 56c formed inside the protective housing 56 by means of a bearing 303. In the embodiment, by setting the support bushing 6 and inserting the outer shaft 32 therein, on the one hand, the support bushing 6 can rotate about the outer shaft 32, and on the other hand, the support bushing 6 can effectively support the winding drum 1 at the end of the winding drum 1, achieving smooth rotation of the winding drum 1. Moreover, the first half shell 561 is integrally formed with the support bushing 6, making it easy to manufacture and disassemble. Meanwhile, by setting the bearing 303 to support the inner shaft 30, it can ensure smooth rotation of the support bushing 6, the protective housing 56, and the winding drum 1 about the inner shaft 30.

In an embodiment, as shown in FIG. 1, and 4-6, the base 4 is a driving housing that covers the winding core shaft 423, the transmission shaft 425, the planar spiral spring 427, the driving gear 428a, and the transition gear 428c. The driving housing 4 is abutted to and fixedly connected to the protective housing 56, and a through hole 403 is defined in a housing wall at one end of the driving housing 4 for the gear surface of the transition gear 428c to extend out. In the embodiment, the driving housing is used as the base 4, which can effectively cover the main components of the rotary power member 42, protect the movable components and achieve modular assembly. Moreover, the driving housing 4 is abutted and fixed to the protective housing 56, which can facilitate synchronous rotation with the winding drum 1.

The embodiments of the present invention have been described above with reference to the accompanying drawings, but the present invention is not limited to the specific implementations described above, and the specific implementations described above are only schematic and not limiting. Under the enlightenment of this invention, many forms can be made without departing from the scope of this invention and the scope of protection of the claims, and these are all included in the scope of protection of this invention.

What is claimed is:

1. A roller shutter driving apparatus, comprising:
a shaft rod fixed to a support frame at an outer side of one end of a winding drum of a roller shutter, and inserted into the winding drum and coaxially arranged with the winding drum;
a driver arranged inside the winding drum for driving the winding drum to rotate about the shaft rod; wherein the driver comprises a base fixed relative to the winding drum in a circumferential direction, and a rotary power member fixed to the base; central axes of an output shaft of the rotary power member and the shaft rod have a predetermined non-zero angle; and
a transmission mechanism arranged between the output shaft and the shaft rod, and comprising a guide rod fixed relative to the base, a guide sleeve slidably fitted about the guide rod, and two connector modules connected to the guide sleeve; wherein the guide sleeve comprises a main sleeve and two sliding rods symmetrically protruding out from opposite sides of the main sleeve;
each connector module comprises a sliding sleeve slidably fitted about a corresponding sliding rod, and an adapter rod rotatably connected to the sliding sleeve with one end; the other ends of the two adapter rods belonging to the two connector modules are respectively fixed to a distal end of the output shaft and a distal end of the shaft rod, and the ends of the adapter rods rotatably connected to the sliding sleeves deviate from the central axes of the output shaft and the shaft rod, respectively.

2. The roller shutter driving apparatus of claim 1, wherein one end of the adapter rod is formed with a U-shaped fork frame, the sliding sleeve protrudes from opposite sidewalls with two circular shafts that are coaxial with each other and perpendicular to an axis of a central hole of the sliding sleeve; the sliding sleeve is placed inside the fork frame, and the circular shafts are inserted into corresponding rotation holes defined in two opposite fork arms of the fork frame.

3. The roller shutter driving apparatus of claim 1, wherein the central axes of the output shaft of the rotary power member and the shaft rod are perpendicular to each other.

4. The roller shutter driving apparatus of claim 1, wherein the shaft rod comprises an inner shaft and an outer shaft that are coaxially fixedly connected, the inner shaft is located entirely inside the winding drum, and defines an insertion hole for receiving a corresponding adapter rod in a sidewall of one end away from the outer shaft; an end of the outer shaft that is away from the inner shaft extends outside the winding drum, and is fixed to the support frame.

5. The roller shutter driving apparatus of claim 4, wherein the rotary power member comprises a winding core shaft and a transmission shaft that are arranged parallel to each other and rotatably mounted to the base, and a planar spiral spring wound on the winding core shaft and fixed at an outer end to the transmission shaft; wherein the transmission shaft is connected to the output shaft through a gear pair for transmission.

6. The roller shutter driving apparatus of claim 5, wherein the gear pair comprises a driving gear fixed coaxially with the transmission shaft, a driven gear fixed coaxially with the output shaft, and a transition gear rotatably mounted to the base and meshing with the driving gear and the driven gear on both sides.

7. The roller shutter driving apparatus of claim 6, wherein the winding core shaft and the transition gear are coaxially arranged and rotatably fitted about a rotation shaft; corresponding shaft holes are defined in the base, for opposite ends of the rotation shaft being inserted therein.

8. The roller shutter driving apparatus of claim 6, further comprising a protective housing that covers the guide rod, the guide sleeve, the connector modules, the output shaft, and the driven gear; wherein the shaft rod and a gear surface of the transition gear respectively extend into the protective housing through openings predetermined defined in opposite sidewalls of the protective housing, the output shaft is rotatably mounted to the protective housing, and opposite ends of the guide rod are respectively inserted and fixed into corresponding positioning holes defined in opposite inner walls of the protective housing.

9. The roller shutter driving apparatus of claim 8, wherein the protective housing is formed by interlocking a first half shell and a second half shell, the first half shell is integrally formed with a support bushing on one end adjacent to the outer shaft, and the outer shaft is correspondingly inserted into the support bushing, the inner shaft is assembled on a corresponding bearing seat formed inside the protective housing by means of a bearing.

10. The roller shutter driving apparatus of claim 8 or 9, wherein the base is a driving housing that covers the winding core shaft, the transmission shaft, the planar spiral spring, the driving gear, and the transition gear; the driving housing is abutted to and fixedly connected to the protective housing, and a through hole is defined in a housing wall at one end of the driving housing for the gear surface of the transition gear to extend out.
